(19) United States
(12) Patent Application Publication
(10) Pub. No.: US 2026/0318679 A1
(43) Pub. Date: Oct. 15, 2026

(54) Vehicle Wheel Sensing Apparatus for Simple and Rapid Mounting to a Vehicle Wheel

(71) Applicant: MONLIZ LLC, Sacramento, CA (US)

(72) Inventors: Lee Lizarraga, Ventura, CA (US); Steven A. Tobenkin, Las Vegas, NV (US); Robert Monaghan, Ventura, CA (US)

(73) Assignee: MONLIZ LLC, Sacramento, CA (US)

(21) Appl. No.: 19/179,137

(22) Filed: Apr. 15, 2025

(51) Int. Cl. G01B 11/275

(52) U.S. Cl. CPC G01B 11/2755

(57) ABSTRACT

An apparatus is provided that simply and rapidly mounts to a vehicle wheel and that generates various measurements for the attached wheel. The apparatus includes a cylindrical housing with a sensory array at its center and several slots that extend from an outer edge of the housing towards the housing center at different angles. The apparatus also includes attachment arms that mount to wheel nuts of a vehicle wheel and that position the housing parallel to the vehicle wheel center. Each attachment arm includes a rigid body, a slot coupler, and a wheel nut coupler. The slot coupler is located near a proximal end and includes grooves that reduce a width or a diameter of the rigid body to fit within the openings of each housing slot. The wheel nut coupler is located at a distal end and provides coupling of the attachment arm to a wheel nut.

### BACKGROUND

Performing vehicle wheel calibration involves setting up and configuring heavy equipment on at least the driving wheels. The equipment takes the form of a heavy wheel alignment clamp (e.g., weighing several pounds) that is mounted to a wheel by careful positioning of the wheel alignment clamp spades between the wheel rim and the tire. Other wheel alignment clamps may be mounted over the tires. The weight and bulk of the wheel alignment clamp is necessary to support a reflector or other equipment off the vehicle wheel that are used for alignment and/or calibration measurements. However, the weight and bulk of the wheel alignment clamp make it difficult to work with such that it takes several minutes to properly mount the clamp to the vehicle wheel. Moreover, the wheel alignment clamp with a mounted reflector may only be used to perform alignment measurements and cannot be used to perform measurements of actual driving characteristics or of the wheels in motion.

FIG. 1 illustrates a prior art example of a wheel alignment clamp used for performing vehicle wheel calibration. Installation of the wheel alignment clamp includes adjusting tire pressure before mounting the wheel alignment clamp to be perpendicular to a lift or the ground surface. To mount the wheel alignment clamp onto the wheel, an installer inserts the spades of the wheel alignment clamp in gaps between the wheel rim and the tire and tightens one or more adjustment knobs to secure the wheel alignment clamp on the wheel. A reflector may be attached to the wheel alignment clamp. Lasers may be bounced off the reflector to measure the angle or position of the wheel. Accordingly, there is a need for wheel calibration equipment that is easier to work with, manipulate, and set up and that may be used to perform measurements of other driving characteristics besides the wheel alignment.

### BRIEF DESCRIPTION OF THE DRAWINGS

FIG. 1 illustrates a prior art example of a wheel alignment clamp used for performing vehicle wheel calibration.

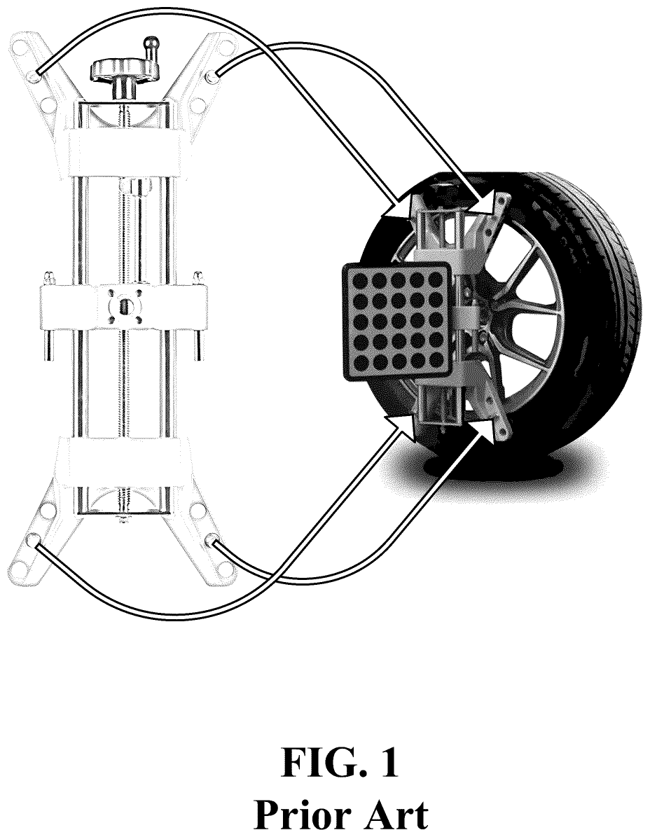

FIG. 2 illustrates an example of a vehicle wheel sensing apparatus attached to two or more nuts of a vehicle wheel in accordance with some embodiments presented herein.

FIG. 3 illustrates a top view of the apparatus housing in accordance with some embodiments presented herein.

FIG. 4 illustrates a side view of the apparatus attachment arms in accordance with some embodiments presented herein.

FIG. 5 illustrates an example of an attachment arm with a compression sleeve in accordance with some embodiments presented herein.

FIG. 6 illustrates an example of mounting the same vehicle wheel sensing apparatus to wheels with different wheel nut configurations in accordance with some embodiments presented herein.

FIG. 7 illustrates an example of the vehicle wheel sensing apparatus implemented with a slot-free design in accordance with some embodiments presented herein.

FIG. 8 presents a process for obtaining wheel measurements using vehicle wheel sensing apparatus in accordance with some embodiments presented herein.

FIG. 9 illustrates examples of detecting different wheel alignment issues using vehicle wheel sensing apparatus in accordance with some embodiments presented herein

FIG. 10 illustrates example components of one or more devices, according to one or more embodiments described herein.

### DETAILED DESCRIPTION OF PREFERRED EMBODIMENTS

The following detailed description refers to the accompanying drawings. The same reference numbers in different drawings may identify the same or similar elements.

Provided is a vehicle wheel sensing apparatus that simply and rapidly mounts to a vehicle wheel and that generates alignment and/or other driving characteristic measurements for the attached wheel. In particular, the vehicle wheel sensing apparatus mounts directly to the wheel nuts using magnets, compression sleeves, nut sockets, and/or other couplers.

The vehicle wheel sensing apparatus includes a circular housing with slots that align with different wheel nut configurations. The vehicle wheel sensing apparatus includes attachment arms that are inserted into two or more of the slots that align with two or more of the wheel nuts. The attachment arms include a wheel nut coupler at their distal end. The wheel nut coupler attaches to an aligned wheel nut using a magnet, compression sleeve, or wheel nut socket that matches or conforms to the shape of the wheel nut.

The attachment arms extend laterally or horizontally from the attached wheel nut couplers and position the circular housing a distance from the center of the vehicle wheel. Specifically, the attachment arms extend perpendicularly from the wheel and retain the circular housing parallel to the center of the wheel.

The circular housing includes or houses a sensory array. The sensory array generates the data and/or measurements for the attached wheel whether the wheel is stationary, moved side-to-side, or rotated. For instance, the sensory array may include a time-of-flight (ToF) sensor that reflects light or lasers off a reflector or other test surface to determine the angle and position of the wheel. In some embodiments, the ToF sensor is activated during a caster sweep (e.g., moving the wheels side-to-side) to accurately measure and adjust the caster angle of the wheels. The sensory array may use the ToF sensor and/or other sensors to obtain additional alignment measurements (e.g., camber and toe measurements) as well as measurements for driving characteristics of the vehicle (e.g., wheel load, tire wear, etc.).

The vehicle wheel sensing apparatus is detached from the wheel by exerting a pull force that is sufficient to overcome the magnetic, compression, hold, or other force coupling the vehicle wheel sensing apparatus to the wheel nuts. The vehicle wheel sensing apparatus is easily mounted to the same wheel or another wheel in a correct parallel position to the wheel by placing attachment arms 203 over or onto the wheel nuts.

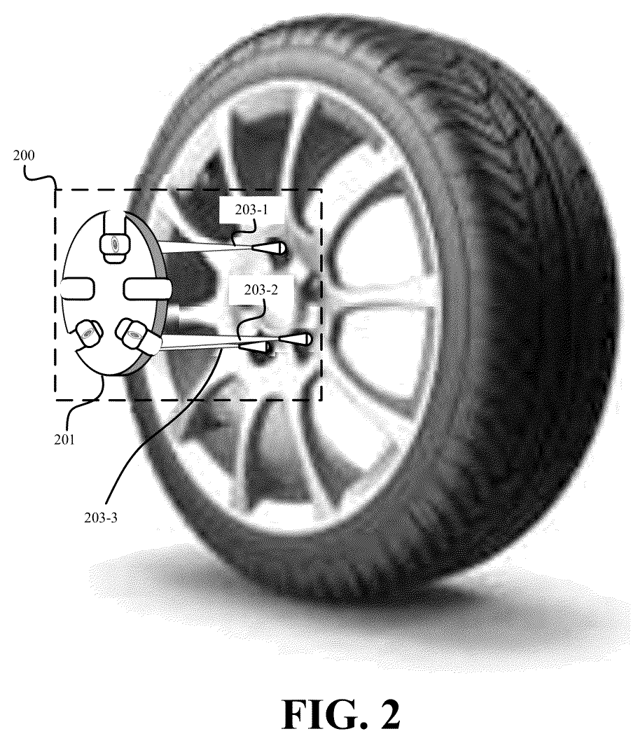

FIG. 2 illustrates an example of vehicle wheel sensing apparatus 200 attached to two or more nuts of a vehicle wheel in accordance with some embodiments presented herein. Apparatus 200 includes housing 201 and attachment arms 203-1, 203-2, and 203-3 (hereinafter collectively referred to as “attachment arms 203” or individually referred to as “attachment arm 203”). In some embodiments, three attachment arms 203 provide sufficient force to retain apparatus 200 parallel to the wheel even when the wheel is rotated or moved side-to-side. In some other embodiments, a different number of attachment arms 203 may be inserted into the slots of housing 201 and coupled to different wheel nuts that align with those attachment arms 203 in order to mount apparatus 200 to the wheel.

The distal end of each attachment arm 203 attaches, connects, or couples to one of the wheel nuts or lug nuts that connect the vehicle wheel to the vehicle axle. In some embodiments, the distal end of attachment arms 203 includes a magnet that is attracted to the metal of the wheel nuts. In some embodiments, the distal end includes a compression sleeve that is elastic. The compression sleeve stretches over and onto a wheel nut and attaches to the wheel nut via a compression force. In some embodiments, the distal end includes a nut socket with a form or pattern that matches the form or pattern of the wheel nuts. The nut socket may also include retractable pins that adapt the nut socket to take the different forms of different wheel nuts.

The proximal end of attachment arms 203 connects to a slot or cutout within housing 201. The position of attachment arm 203 is fixed within a particular slot or cutout using clamps or anchors within grooves of attachment arm 203 that attach to supports within the particular slot or cutout. The supports are positioned in each slot at equal distances from the housing 201 center. In some embodiments, each slot or cutout includes multiple supports that conform with different wheel nut configurations or placements. For instance, each slot may include a first set of supports that are 2 inches from the housing 201 center and a second set of supports that are 3 inches from the housing 201 center. The first set of supports may align with wheel nuts of a first vehicle that are 2 inches away from the wheel center, and the second set of supports may align with wheel nuts of a second vehicle that are 3 inches away from the wheel center.

By attaching attachment arms 203 directly to the wheel nuts and because attachment arms 203 are an equidistant length from the center of housing 201, attachment arms 203 position housing 201 directly over the wheel center and parallel to the wheel. The lateral separation between housing 201 and the wheel improves the accuracy of the measurements by amplifying any offset or deviation in the wheel alignment or rotation.

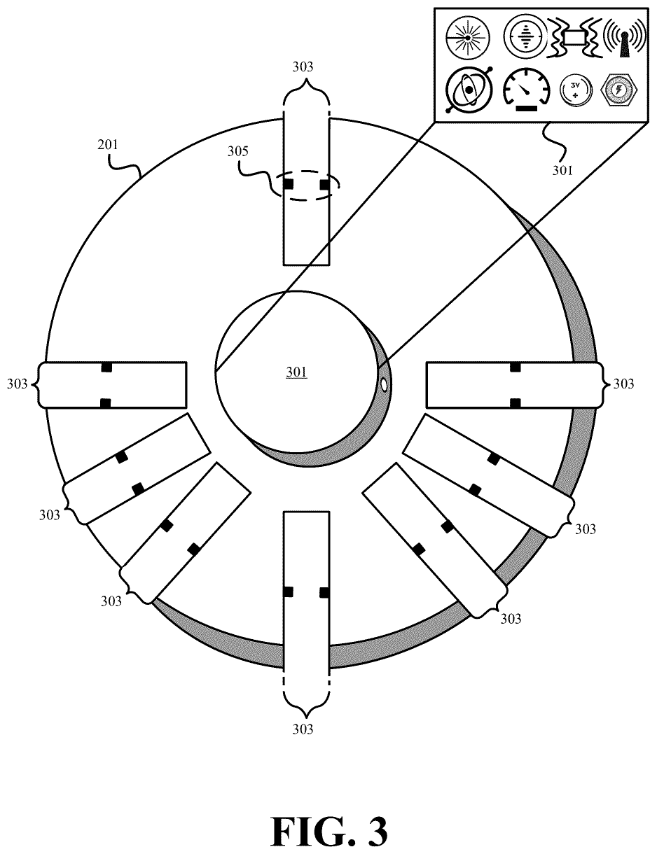

FIG. 3 illustrates a top view of housing 201 in accordance with some embodiments presented herein. Housing 201 is a plastic or metal cylindrical or disc-like structure that retains sensory array 301 at its center and with slots 203 positioned at predefined angles that align with different wheel nut configurations. For instance, wheels for different vehicles may have between 4 and 8 wheel nuts. The wheel nuts of a 4 wheel nut configuration are separated by 90 degrees, the wheel nuts of a 5 wheel nut configuration are separated by 72 degrees, the wheel nuts of a 6 wheel nut configuration are separated by 60 degrees, and the wheel nuts of a 8 nut configuration are separated by 45 degrees. To accommodate these different wheel nut configurations, housing 201 may include slots 203 at 0 degrees (e.g., top position) and two or more of 90 degrees (from the 0 degree top position), 135 degrees, 144 degrees, 180 degrees, 216 degrees, 225 degrees, and 270 degrees. Apparatus 200 requires a minimum of three attachment arms 203 in three slots to mount or attach to a vehicle wheel. More attachment arms 203 may be used for a more secure coupling of apparatus 200 to the vehicle wheel.

Each slot 303 may include one or more pins or supports 305. Pins or supports 305 may include protrusions that extend towards one another from either side of a slot 303. Attachment arms 203 lock onto pins or supports 305 to fix their position about housing 201. The position of pins or supports 305 from the center of housing 201 aligns with the positions of the wheel nuts from the center of the wheel. In some embodiments, pins or supports 305 are located 2 inches from the center of housing 201. In some embodiments, each slot 303 may include multiple pairs of pins or supports 305 to align with wheel nuts at different distances from the center of the wheel.

In some embodiments, housing 201 may have a diameter between 4-10 inches and a thickness between ¼ inches and 1 inch. Housing 201 weighs less than 2 pounds. Since housing 201 is smaller and lighter than traditional wheel alignment clamps, housing 201 with or without attachment arms 203 is significantly easier to work with, manipulate, and set up than traditional wheel alignment clamps.

In some embodiments, sensory array 301 is integrated as part of housing 201 about the center of housing 201. In some such embodiments, sensory array 301 may be flush with the rest of housing 201. In some other such embodiments, sensory array may be raised one or more inches over the surface of housing 201 to provide clearance for sensors within sensory array 301 to emit light or lasers and/or to obtain measurements without obstruction from housing 201. Moreover, sensory array 301 may be rotated within housing 201 to orient the sensors to be parallel or perpendicular to the ground surface or oriented in a specific manner to perform specific diagnostics or measurements.

Sensory array 301 includes a set of sensors that obtain different measurements for the wheel on which vehicle wheel sensing apparatus 200 is mounted. Sensory array 301 may include one or more of a ToF sensor, inertial measurement unit (IMU), accelerometer, gyroscope, vibration sensor, and/or other sensors or integrated circuits for measuring the wheel's arc-of-rotation, acceleration, angular velocity, angle, orientation, height, and position.

The ToF sensor may include an emitter and receiver for measuring the wheel position and/or orientation. Sensory array 301 may be rotated within housing 201 to orient the ToF sensor parallel to the ground surface and to point directly towards a reflector. The ToF sensor may measure the angle with which the emitted light or lasers reflect off the reflector. Multiple such measurements may be taken during a caster sweep or other diagnostic to accurately measure the wheel alignment, the wheel position, and/or the wheel orientation (e.g., toe, camber, caster, etc.).

The IMU may measure acceleration, orientation, angular rates, and other gravitational forces of a wheel or tire mounted on the wheel. In some embodiments, the accelerometer and/or gyroscope control the sampling rate of IMU. For instance, the accelerometer and/or gyroscope may track the position of vehicle wheel sensing apparatus 200 relative to the wheel or road (e.g., at the bottom, bottom left, bottom right, top, etc. of the wheel) as the wheel rotates, and may control the IMU in taking measurements when the IMU or vehicle wheel sensing apparatus 200 moves to the same set of positions (e.g., bottom left, bottom right, and top) during every wheel rotation.

The vibration sensors measure the frequencies at which different vehicle components resonate when the vehicle is in motion or is operational. The vibration sensors are sensors that monitor multiple different vehicle components and may be used to eliminate or replace many of the specialized vehicle sensors that monitor only a single component and/or a single aspect of the component. For instance, the engine, struts, shocks, axels, transmission, brakes, tires, and other vehicle components are manufactured with different materials and function differently (e.g., involve combustion, compress and expand, rotate at different speeds, etc.). Accordingly, each of these components may produce different harmonics in different frequency ranges when the component is operational or when the vehicle is in motion. The vibration sensors may capture and measure these harmonics across the different frequency ranges. By determining, isolating, modeling, and/or analyzing the harmonics and/or frequency ranges of the different vehicle components, vehicle wheel sensing apparatus 200 may detect faults, issues, and/or preemptive failures associated with each of the different vehicle components using only the vibration sensors and the vibrational analysis.

In some embodiments, vehicle wheel sensing apparatus 200 mounted to different wheels of the same vehicle may generate measurements that may be compared to one another. For instance, the angle of the front wheels may be compared against each other to determine the wheel alignment and/or whether one wheel is angled differently than another wheel. Additionally, based on the compared measurements, a controlling device may determine different loads on the wheels, calculate wear on the tires, changes in wheel alignment, and/or changes to other driving characteristics.

Sensory array 301 may also include a transceiver and a power unit. The transceiver may include a Bluetooth, Bluetooth Low Energy, or other low-power radio for communicating with a controlling device, transferring data to the controlling device, and/or receiving commands or configuration data from the controlling device. For instance, the controlling device may pair with each vehicle wheel sensing apparatus 200 that is within wireless range of the controlling device, may configure certain tests or measurements to be performed via a selective activation of the sensors, and may receive and present the test data and/or measurements for viewing. The controlling device may be a smartphone, tablet, or other wireless computing device. The controlling device may also be a microchip on the vehicle for periodically measuring vehicle state. The power unit may include a battery that continuously or selectively powers vehicle wheel sensing apparatus 200. For instance, the power unit may power the accelerometer when the vehicle wheel is not moving, and may power all sensors once the accelerometer determines that the vehicle wheel is in motion. In some embodiments, the power unit may include a rotational power generator (e.g., magnets) that generates power from the rotation of the vehicle wheel in a quantity that is sufficient to power the sensors and other components of vehicle wheel sensing apparatus 200 even with the vehicle moving at low speeds (e.g., 2 or more miles per hour).

In some embodiments, sensory array 301 is detachable from housing 201. In some such embodiments, housing 201 includes a circular indentation about its center and sensory array 301 is contained within a case that fits within the circular indentation. The circular indentation may include a magnet or threading for coupling sensory array 301 to housing 201. For instance, sensory array 301 may include an opposite polarity magnet for coupling to the magnet in the circular indentation of housing 201 or inner threading to screw onto the outer threading of the circular indentation.

Sensory array 301 may be integrated in a separate casing to make battery recharging or replacement easier and/or to allow sensory array 301 to be replaced without having to replace all of vehicle wheel sensing apparatus 200 when one or more sensors are damaged or become inoperable. Similarly, the separate casing allows sensory array 301 to be updated with new sensors or components without having to replace all of vehicle wheel sensing apparatus 200. Moreover, the separate casing allows sensory array 301 to rotate within housing 201 so that the sensors may be positioned or oriented in any required direction. As noted above, the rotation of sensory array 301 may be used to align ToF sensor and/or other sensors of sensory array 301 with reflectors, other vehicle wheel sensing apparatus 200, a ground surface, and/or in required directions for specific measurements or diagnostics.

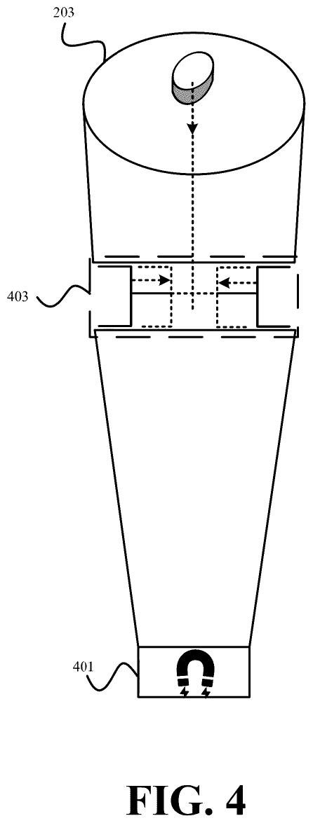

FIG. 4 illustrates a side view of attachment arm 203 in accordance with some embodiments presented herein. Attachment arm 203 may have a conical or cylindrical body that extends 4-12 inches in length and that has a width or diameter between 0.25 and 1 inch. All attachment arms 203 connected to housing 201 have the same length so as to position vehicle wheel sensing apparatus 200 parallel to the center of the mounted wheel. The body of attachment arm 203 may be made of plastic or metal. Attachment arm 203 includes magnet 401 at a distal end and slot coupler 403 towards a proximal end.

Magnet 401 may be a permanent magnet with a polarity that attracts and attaches to the metal of the wheel nuts. The magnetic force is sufficient to retain vehicle wheel sensing apparatus 200 parallel relative to the vehicle wheel and prevent vehicle wheel sensing apparatus 200 from moving relative to the wheel nut when the wheel is in motion.

Slot coupler 403 may include grooves in the body of attachment arm 203 that are sized to slide into and out from slots 203. The body of attachment arm 203 that is directly above and below the grooves has a larger width or diameter than slots 203, thereby preventing attachment arm 203 from passing through or tilting once attachment arm 203 is slid into a slot 303.

Slot coupler 403 is used to fix the position of attachment arm 203 within a slot 303 and prevent attachment arm 203 from sliding in and out of slot 303. To retain the position of attachment arm 203 within slot 303, slot coupler 403 may include a push button at the top of attachment arm 203 that retracts clamps or anchors within the grooves of attachment arm 203. The clamps or anchors are moveable elements that retract by one or more centimeters when the push button is pressed down and that extend outwards from the center of attachment arm 203 when the push button is released. The clamps or anchors are sized to press against and/or attach to pins or supports 305 of each slot 303 when extended outwards. Accordingly, attaching attachment arm 203 to housing 201 includes sliding the grooves of attachment arm 203 into a slot 303 until contact is made with the pins or supports in that slot 303, pressing the push button to retract the clamps or anchors, sliding attachment arm 203 over the pins or supports, and releasing the push bottom to extend the clamps or anchors onto or over the pins or supports, thereby locking attachment arm 203 into place in slot 303.

In some embodiments, attachment arm 203 locks into place in slot 303 of housing 201 via other means. For instance, the grooves may include magnets that attach to pins or supports 305 in a slot 303. In some other embodiments, the grooves may include U or C-shaped locking guides that slide and attach onto pins or supports 305.

In some embodiments, attachment arms 203 use a different wheel nut coupler other than magnet 401 to couple to the vehicle wheel. For instance, the distal end of attachment arms 203 may include compression sleeves or wheel nut sockets instead of magnets 401.

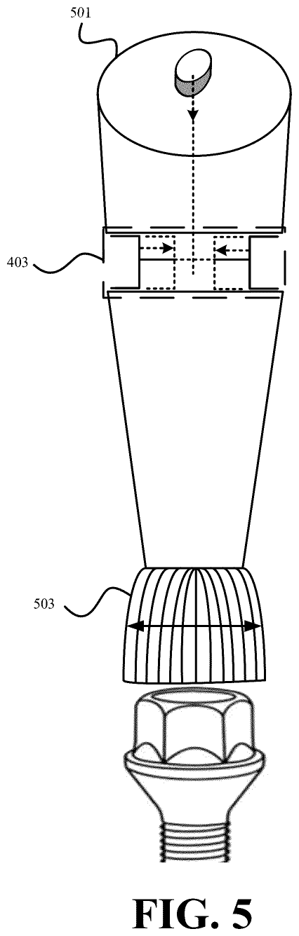

FIG. 5 illustrates an example of attachment arm 501 with compression sleeve 503 in accordance with some embodiments presented herein. Compression sleeve 503 is located at the distal end of attachment arm 501.

Compression sleeve 503 is an elastic sheath that may have the shape of a wheel nut, a cylindrical shape, or another shape that conforms to the shape of the wheel nut. The elastic sheath is rigid and does not bend lengthwise or vertically but is flexible and expands widthwise or laterally when an object is inserted into compression sleeve 503. For instance, compression sleeve 503 has a diameter that is less than the diameter of the wheel nut. Compression sleeve 503 is slid over or pressed onto the wheel nut. Compression sleeve 503 expands as it is pushed onto the wheel nut causing compression sleeve 503 to firmly attach to the wheel nut. Compression sleeve 503 holds attachment arm 501 perpendicular to the vehicle wheel or the wheel nut which in turn holds support vehicle wheel sensing apparatus 200 parallel to the center of the vehicle wheel.

In some embodiments, compression sleeve 503 is replaced by a universal wheel nut socket or an adaptive wheel nut socket. The adaptive wheel nut socket may include retractable or compressible pins that change the form of the wheel nut socket to fit and/or lock onto different shaped wheel nuts.

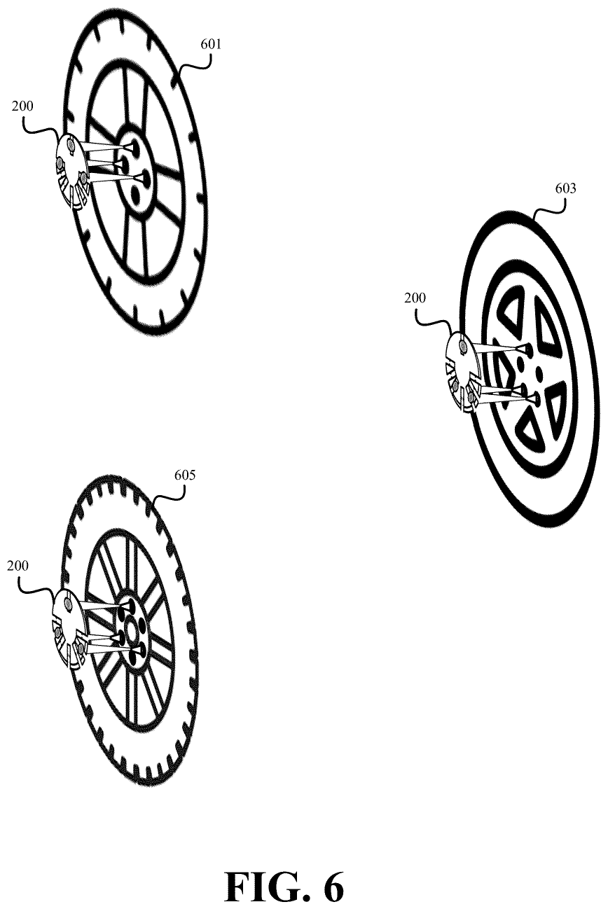

FIG. 6 illustrates an example of mounting the same vehicle wheel sensing apparatus 200 to wheels with different wheel nut configurations in accordance with some embodiments presented herein. In particular, FIG. 6 illustrates vehicle wheel sensing apparatus 200 mounting to wheel 601 with a 4-nut configuration, wheel 603 with a 5-nut configuration, and wheel 605 with a 6-nut configuration.

Vehicle wheel sensing apparatus 200 mounts to each of the different wheels 601, 603, and 605 by placing attachment arms 203 in different slots 203 of housing 201 that align with any 3 nuts of the different wheels 601, 603, and 605. As shown in FIG. 6, vehicle wheel sensing apparatus 200 mounts to the 4-nut configuration of wheel 601 using attachment arms 203 that are inserted and locked into place in slots 203 at the 0-degree position, 90-degree position, and 270-degree position. Vehicle wheel sensing apparatus 200 mounts to the 5-nut configuration of wheel 603 using attachment arms 203 that are inserted and locked into place in slots 203 at the 0-degree position, 144-degree position, and 216-degree position. Vehicle wheel sensing apparatus 200 mounts to the 6-nut configuration of wheel 605 using attachment arms 203 that are inserted and locked into place in slots 203 at the 0-degree position, 120-degree position, and 240-degree position.

Vehicle wheel sensing apparatus 200 may mount to the wheel nuts using different structures or embodiments for housing 201 and/or attachment arms 203. In some embodiments, vehicle wheel sensing apparatus 200 is implemented with a slot-free design and attachment arms that connect to the housing with magnets.

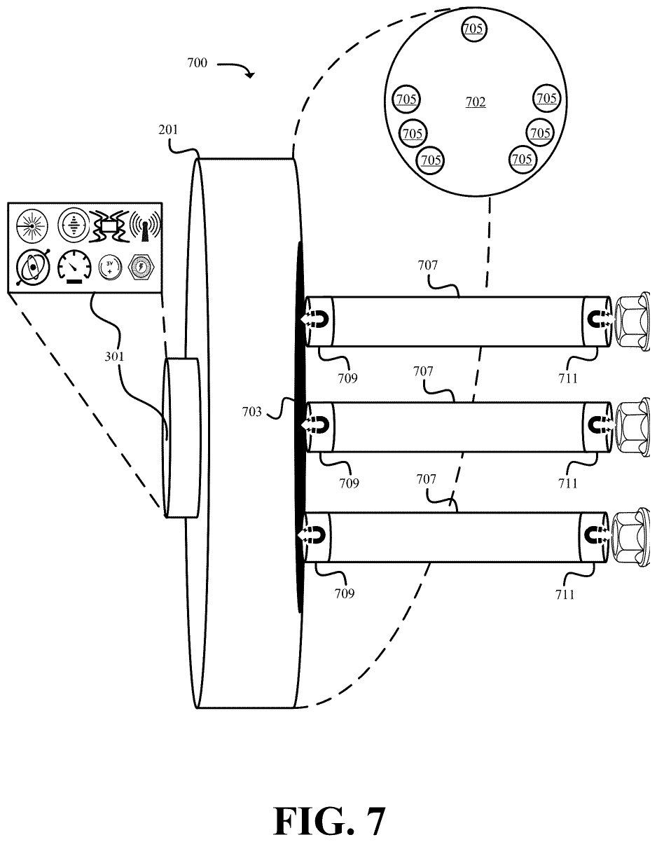

FIG. 7 illustrates an example of vehicle wheel sensing apparatus 700 implemented with a slot-free design in accordance with some embodiments presented herein. Vehicle wheel sensing apparatus 700 includes housing 701. Housing 701 is a continuous cylindrical or disc-like structure. Housing 701 includes sensory array 301 at its center. Sensory array 301 may be integrated into housing 701 or may attach and detach from housing 701 via magnets or other coupling means. Sensory array 301 rotates within housing 701 so that various sensors (e.g., the ToF sensor) may be oriented or positioned in a desired direction and/or orientation.

Housing 701 includes metal 703 along the interior or exterior of the housing 701 backside or side that face the vehicle wheel during mounting. Metal 703 may include a circular metal sheet that is attached at the center of the housing 701 back (e.g., about the interior or exterior). The diameter of the circular metal sheet is equal to or slightly greater than the distance between opposing wheel nuts. For instance, the circular metal sheet has a diameter between 4 and 8 inches. As shown in the back view 702 of housing 701 some embodiments, the backside of housing 701 includes markers 705 that align with the positioning of different wheel nut configurations. Markers 705 may include printed elements or indentations in housing 701 that indicate where to attach attachment arms 707 to housing 701 so that housing 701 is positioned about the center of the vehicle wheel when mounted on the vehicle wheel. In some other embodiments, metal 703 may include several metallic disks that are positioned about the backside to align with the positions of different wheel nuts and/or the position of markers 705.

Attachment arms 707 connect to housing 701 via magnets 709 at their respective proximal end. Attachment arms 707 also include magnets 711 at their respective distal end to mount or attach to the wheel nuts. Attachment arms 707 include solid metal or plastic rods between magnets 709 and 711.

Accordingly, mounting vehicle wheel sensing apparatus 700 to a vehicle wheel includes attaching magnets 7011 at the distal end of two or more attachment arms 707 to two or more wheel nuts of the vehicle wheel via magnetism. The two or more attachment arms 707 extend perpendicularly from the vehicle wheel. The markers 705 about the backside of housing 701 are aligned and attached to magnets 709 at the proximal end of the two or more attachment arms 707 via magnetism. Attachment arms 707 position and retain housing 701 perpendicular to the vehicle wheel about the wheel center.

In some embodiments, metal 703 is replaced with a magnet and magnets 709 at the proximal end of attachment arms 707 may be replaced with metal. In some other embodiments, markers 705 about the backside of housing 701 are replaced with inner-threaded grooves and the proximal end of attachment arms 707 are replaced with outer-threaded extensions that may be screwed into the inner-threaded grooves in order to couple attachment arms 707 to the backside of housing 701.

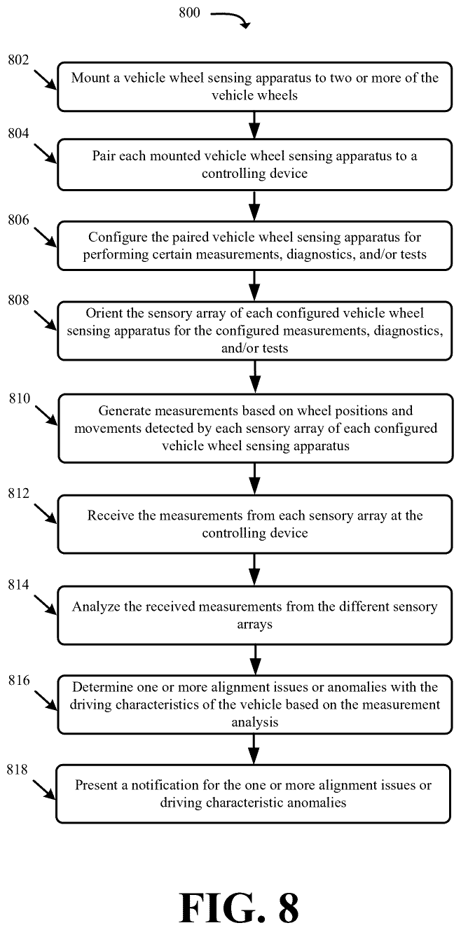

FIG. 8 presents a process 800 for obtaining wheel measurements using vehicle wheel sensing apparatus 200 or 700 in accordance with some embodiments presented herein. The wheel measurements may be used for wheel alignment and/or tuning of other vehicle driving characteristics.

Process 800 includes mounting (at 802) vehicle wheel sensing apparatus 200 to two or more of the vehicle wheels. In some embodiments, vehicle wheel sensing apparatus 200 is mounted (at 802) to the drive wheels or the front wheels. In some other embodiments, vehicle wheel sensing apparatus 200 is mounted to all wheels.

Mounting (at 802) vehicle wheel sensing apparatus 200 includes inserting attachment arms 203 into slots 203 that align with the wheel nut configuration of the vehicle wheels and locking attachment arms 203 into place using the pins or supports of the selected slots 203 and slot coupler 403 of attachment arms 203. Mounting (at 802) vehicle wheel sensing apparatus 200 further includes coupling the distal ends of attachment arms 203 to the aligned wheel nuts. The coupling may be via magnetic force, compression, or placement of the nut sockets over the wheel nuts.

Process 800 includes pairing (at 804) each mounted (at 802) vehicle wheel sensing apparatus 200 to a controlling device. The controlling device may include any in-range wireless computing device such as a tablet, smartphone, or laptop. The pairing (at 804) may be conducted via Bluetooth or WiFi. Vehicle wheel sensing apparatus 200 begin the pairing (at 804) procedure upon being powered on via the press and/or hold of a power or activation button on each vehicle wheel sensing apparatus 200. The pairing (at 804) procedure includes sending a discovery message from each vehicle wheel sensing apparatus 200 that the controlling device detects and uses to identify and connect to each vehicle wheel sensing apparatus 200. Vehicle wheel sensing apparatus 200 that are previously paired with the controlling device may establish a network connection with the controlling device without performing the pairing procedure anew.

Process 800 includes configuring (at 806) the paired (at 804) vehicle wheel sensing apparatus 200 for performing certain measurements, diagnostics, and/or tests. For instance, the controlling device may issue commands to activate sensory array 301 of each vehicle wheel sensing apparatus 200, wherein activating sensory array 301 includes configuring (at 806) the sensory array 301 to take one or more types of measurements and wirelessly transmit the measurements to the controlling device.

Process 800 includes orienting (at 808) sensory array 301 of each configured (at 806) vehicle wheel sensing apparatus 200 for the configured (at 806) measurements, diagnostics, and/or tests. Orienting (at 808) sensory array 301 includes rotating sensory array 301 within housing 201 to have a specific orientation relative to the mounted wheel, ground surface, or other object. For instance, the configured (at 806) diagnostics may include performing a caster sweep using the ToF sensor. In this instance, the ToF sensor within sensory array 301 should be directed towards a reflector such that the angles and arc-of-rotation may be accurately measured based on the phase shift or time difference of emitted light or lasers from the ToF sensor reflecting off the reflector back to the ToF sensor.

Process 800 includes generating (at 810) the measurements based on wheel positions and movements detected by each sensory array 301 of each configured (at 806) vehicle wheel sensing apparatus 200. In some embodiments, the measurements may be generated (at 810) with the wheels in a stationary or static position. In some such embodiments, the measurements may identify the wheel toe (e.g., angle that the wheels are offset from the vehicle centerline) or wheel camber (e.g., angle that the wheels are offset from a vertical position). In some other embodiments, the measurements may be generated (at 810) as the wheels rotate in a forward or backward motion or are moved in a side-to-side motion. In some such embodiments, the measurements may provide more accurate readings for the wheel toe, camber, and/or caster. For instance, the wheels may be turned right and left to specific angles as part of performing a caster sweep in order to measure the front caster angle. Similarly, the vehicle may be moved forward and/or backward to obtain different toe, camber, and/or other wheel alignment measurements at different wheel positions.

Process 800 includes receiving (at 812) the measurements from each sensory array 301 at the controlling device. Each sensory array 301 includes a transceiver for wirelessly distributing the data for the generated (at 810) measurements to the controlling device.

Process 800 includes analyzing (at 814) the received (at 812) measurements from the different sensory arrays 301. The analysis (at 812) may include comparing the measurements from the different sensory arrays 301 to one another or comparing the measurements against manufacturer specified tolerances or measurements.

Process 800 includes determining (at 816) one or more alignment issues or anomalies with the driving characteristics of the vehicle based on the measurement analysis (at 814). For instance, the controlling device may determine (at 816) the camber, toe, caster, and/or other wheel alignment characteristics associated with each wheel based on the measurement analysis (at 814) or other driving characteristics including the tire wear state, wheel balance, changes in vehicle traction, changes in gas mileage, and/or other changes affecting the performance of the wheels or vehicle. The determination (at 816) of the alignment issues or anomalies may be made in response to one or more measurements deviating from manufacturer specified tolerances, settings, or values.

Process 800 includes presenting (at 818) a notification for the one or more alignment issues or driving characteristic anomalies. The notification may be presented in a graphical user interface on the controlling device or as alerts or indicators that are illuminated on the vehicle dashboard or console. The notification may include instructions for tuning the wheels or vehicle to return the alignment and/or driving characteristics to within manufacturer tolerances or specifications.

In some embodiments, the controlling device may automatically adjust or tune the vehicle driving characteristics based on the generated (at 810) measurements and/or determined (at 816) anomalies. The controlling device may automatically adjust or tune the vehicle driving characteristics to improve vehicle efficiency and/or performance. For instance, the controlling device may redistribute power to the wheel motors in order to reduce tire wear and/or improve tire life based on the angle or orientation with which the wheels ride on the road which may be indicative of the load on the wheels.

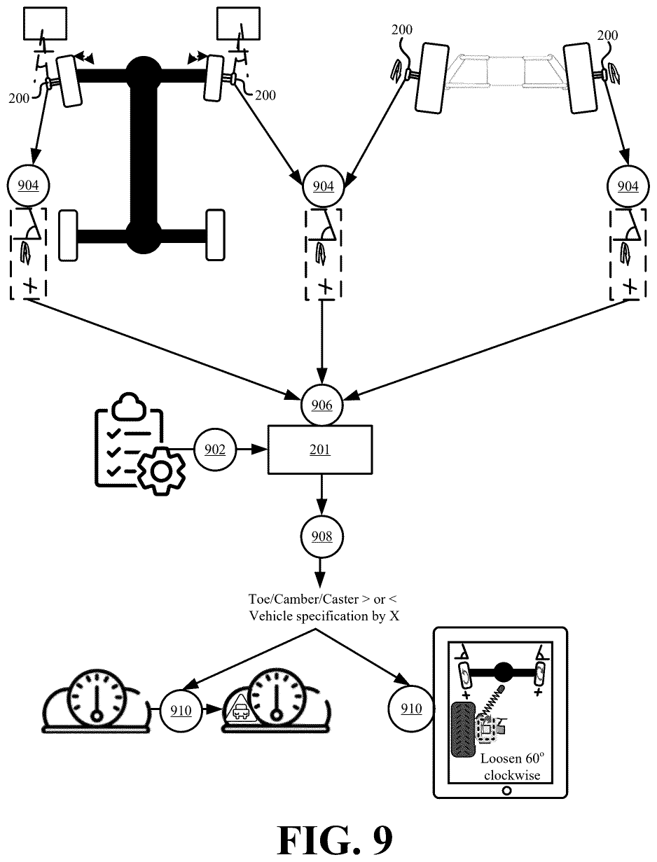

FIG. 9 illustrates examples of detecting different wheel alignment issues using vehicle wheel sensing apparatus 200 in accordance with some embodiments presented herein. To detect the wheel alignment issues, controlling device 901 is configured (at 902) with manufacturer or vehicle specifications or acceptable tolerances for correct wheel alignment (e.g., correct values for wheel toe, camber, and caster). In some embodiments, a user enters the year, make, and model of the vehicle into controlling device 901, and controlling device 901 retrieves the manufacturer or vehicle specifications or acceptable tolerances for the specified year, make, and model from a database.

Controlling device 901 activates each vehicle wheel sensing apparatus 200 to measure (at 904) one or more of each wheel's angle, orientation, position, and/or arc-of-rotation from a stationary position, as the wheel is moved side-to-side, or as the wheel rotates. For instance, controlling device 901 may activate the ToF sensor, IMU, and/or other sensors to obtain unique or different measurements for the wheel's angle, orientation, position, and/or arc-of-rotation. The ToF sensor may obtain measurements based on phase shifts and/or time differences for light reflecting off a reflector, and the IMU may obtain similar measurements based on detected acceleration and/or angular velocity.

Vehicle wheel sensing apparatus 200 transmit (at 906) the measurements to controlling device 901. Controlling device 901 compares and/or analyzes the measurements to determine (at 908) driving characteristics that are outside of the manufacturer or vehicle specifications or acceptable tolerances. For instance, the arc-of-rotation, angle, orientation, and/or position of a wheel may have an inward or outward positioning that deviates by more than a threshold amount from the manufacturer or vehicle specified amount of wheel toe. Similarly, controlling device 901 detects a misaligned wheel based on the arc-of-rotation, angle, orientation, and/or position of a wheel indicating that the angle or tilt of the wheel deviates by more than a threshold amount from the manufacturer or vehicle specified amount of wheel camber. In some embodiments, controlling device 901 detects a misaligned wheel based on the arc-of-rotation, angle, orientation, and/or position of a wheel indicating that the wheel does not return to center or a straight position after a turn, and therefore has a caster that deviates by more than a threshold amount from the manufacturer or vehicle specified amount of caster.

Controlling device 901 may generate (at 910) an alert on the vehicle dashboard or console to notify the driver of the detected issues. Alternatively, controlling device 901 may present (at 910) the anomalous driving characteristics on a display or user interface, and may include instructions for correcting the anomalous driving characteristics. The instructions may specify the vehicle component that needs adjustments and the amount of adjustment to bring operation of that vehicle component back to within the manufacturer or vehicle specifications or acceptable tolerances.

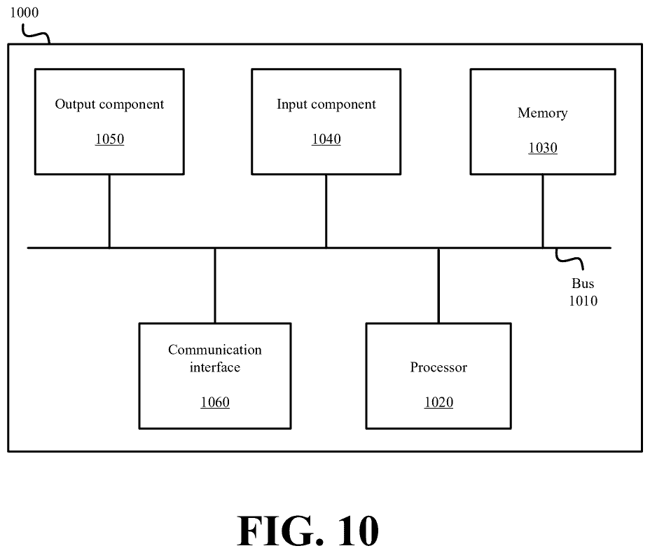

FIG. 10 is a diagram of example components of device 1000. Device 1000 may be used to implement one or more of the devices or systems described above (e.g., vehicle wheel sensing apparatus 200, controlling device 901, etc.). Device 1000 may include bus 1010, processor 1020, memory 1030, input component 1040, output component 1050, and communication interface 1060. In another implementation, device 1000 may include additional, fewer, different, or differently arranged components.

Bus 1010 may include one or more communication paths that permit communication among the components of device 1000. Processor 1020 may include a processor, microprocessor, or processing logic that may interpret and execute instructions. Memory 1030 may include any type of dynamic storage device that may store information and instructions for execution by processor 1020, and/or any type of non-volatile storage device that may store information for use by processor 1020.

Input component 1040 may include a mechanism that permits an operator to input information to device 1000, such as a keyboard, a keypad, a button, a switch, etc. Output component 1050 may include a mechanism that outputs information to the operator, such as a display, a speaker, one or more light emitting diodes (LEDs), etc.

Communication interface 1060 may include any transceiver-like mechanism that enables device 1000 to communicate with other devices and/or systems. For example, communication interface 1060 may include an Ethernet interface, an optical interface, a coaxial interface, or the like. Communication interface 1060 may include a wireless communication device, such as an infrared (IR) receiver, a Bluetooth® radio, or the like. The wireless communication device may be coupled to an external device, such as a remote control, a wireless keyboard, a mobile telephone, etc. In some embodiments, device 1000 may include more than one communication interface 1060. For instance, device 1000 may include an optical interface and an Ethernet interface.

Device 1000 may perform certain operations relating to one or more processes described above. Device 1000 may perform these operations in response to processor 1020 executing software instructions stored in a computer-readable medium, such as memory 1030. A computer-readable medium may be defined as a non-transitory memory device. A memory device may include space within a single physical memory device or spread across multiple physical memory devices. The software instructions may be read into memory 1030 from another computer-readable medium or from another device. The software instructions stored in memory 1030 may cause processor 1020 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

The actual software code or specialized control hardware used to implement an embodiment is not limiting of the embodiment. Thus, the operation and behavior of the embodiment has been described without reference to the specific software code, it being understood that software and control hardware may be designed based on the description herein.

For example, while series of messages, blocks, and/or signals have been described with regard to some of the above figures, the order of the messages, blocks, and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, while some devices are shown as communicating with a network, some such devices may be incorporated, in whole or in part, as a part of the network.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well-known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Some implementations described herein may be described in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “exceeding” a threshold (or similar terms) may be used interchangeably with “being greater than a threshold,” “being greater than or equal to a threshold,” “being less than a threshold,” “being less than or equal to a threshold,” or other similar terms, depending on the context in which the threshold is used.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

1. An apparatus comprising:
a cylindrical housing comprising:
a sensory array located at a center of the cylindrical housing; and
a plurality of slots corresponding to openings that extend from an outer edge of the cylindrical housing towards the center of the cylindrical housing at different angles; and
a plurality of attachment arms that mount to a plurality of wheel nuts about a center of a vehicle wheel and that position the cylindrical housing parallel to a center of the vehicle wheel, wherein each attachment arm of the plurality of attachment arms comprises:
a rigid body that extends lengthwise to a particular distance;
a slot coupler that is located near a proximal end of the attachment arm, wherein the slot coupler corresponds to grooves that reduce a width or a diameter of the rigid body where the slot coupler is located to fit within the openings of each slot of the plurality of slots, and wherein the rigid body above and below the slot coupler has a larger width or diameter than the openings of each slot of the plurality of slots; and
a wheel nut coupler that is located at a distal end of the attachment arm, the wheel nut coupler providing coupling of the attachment arm to a wheel nut of the vehicle wheel.

2. The apparatus of claim 1,
wherein the cylindrical housing further comprises an indentation at the center of the cylindrical housing, and
wherein the sensory array comprises a structure that attaches to and detaches from the indentation at the center of the cylindrical housing.

3. The apparatus of claim 2, wherein the indentation comprises a magnet, and wherein the structure of the sensory array attaches to the indentation via a magnetic force.

4. The apparatus of claim 2, wherein the indentation comprises threading, and wherein the structure of the sensory array attaches to the indentation by screwing onto the threading.

5. The apparatus of claim 1, wherein the sensory array rotates about the center of the cylindrical housing.

6. The apparatus of claim 1, wherein the sensory array comprises:
a time-of-flight (ToF) sensor that measures wheel alignment characteristics based on emitted light that reflects off a reflector that is positioned perpendicular to the vehicle wheel.

7. The apparatus of claim 1, wherein the sensory array comprises:
two or more of an inertial measurement unit (IMU), accelerometer, gyroscope, and vibration sensor.

8. The apparatus of claim 1, wherein the sensory array comprises:
a plurality of sensors that measure two or more of an arc-of-rotation, acceleration, angular velocity, angle, orientation, height, and position of the vehicle wheel.

9. The apparatus of claim 1, wherein each slot of the plurality of slots comprises:
a pair of supports located at a same depth in each slot of the plurality of slots, wherein the pair of supports correspond to protrusions that extend from opposite sides of a slot towards a center of the slot.

10. The apparatus of claim 9, wherein the slot coupler of a particular attachment arm comprises:
retractable clamps that retract to reduce the width or the diameter of the rigid body where the slot coupler is located to slide past the pair of supports and that extend to lock a position of the particular attachment arm against the pair of supports.

11. The apparatus of claim 9, wherein the slot coupler of the particular attachment arm further comprises:
a push button that retracts the retractable clamps in response to being pressed and that extends the retractable clamps when the push button is not pressed.

12. The apparatus of claim 1, wherein the plurality of slots comprise:
a first slot at a 0 degree position of the cylindrical housing that aligns with a first wheel nut of a vehicle wheel with a 4-nut, 5-nut, or 6-nut configuration;
a second slot at a 90 degree position that aligns with a second wheel nut of the vehicle wheel with the 4-nut configuration;
a third slot at a 144 degree position that aligns with a second wheel nut of the vehicle wheel with the 5-nut configuration; and
a third slot at a 120 degree position that aligns with a second wheel nut of the vehicle wheel with the 6-nut configuration.

13. The apparatus of claim 1, wherein the wheel nut coupler is a magnet that couples to the wheel nut with magnetism.

14. The apparatus of claim 1, wherein the wheel nut coupler is a compression sleeve that expands in response to sliding over the wheel nut and that couples to the wheel nut based on compression of the compression sleeve over the wheel nut.

15. A vehicle wheel sensing apparatus comprising:
a housing comprising:
a sensory array located at a center of the housing; and
a plurality of openings that extend from an outer edge of the housing at a plurality of angles that align with wheel nuts in two or more of a 4-nut, 5-nut, 6-nut, or 8-nut configuration; and
a plurality of interchangeable arms that attach to different sets of the plurality of openings as part of mounting of the vehicle wheel sensing apparatus to different vehicle wheels with the 4-nut, 5-nut, 6-nut, or 8-nut configuration.

16. The vehicle wheel sensing apparatus of claim 15, wherein each interchangeable arm of the plurality of interchangeable arms comprises:
a magnet at a distal end that couples with a magnetic force to a wheel nut.

17. The vehicle wheel sensing apparatus of claim 15, wherein each interchangeable arm of the plurality of interchangeable arms comprises:
a compression sleeve at a distal end that attaches to a wheel nut by sliding over the wheel nut and attaching to the wheel nut with a compression force.

18. The vehicle wheel sensing apparatus of claim 15, wherein each interchangeable arm of the plurality of interchangeable arms comprises:
retractable clamps that retract to reduce a width or a diameter of a section of the interchangeable arm to slide into an opening of the plurality of openings and that extend to lock a position of the attachment arm within the opening.

19. The vehicle wheel sensing apparatus of claim 18, wherein each interchangeable arm of the plurality of interchangeable arms further comprises:
a push button that retracts the retractable clamps in response to being pressed and that extends the retractable clamps when the push button is not pressed.

20. An apparatus comprising:
a cylindrical housing comprising:
a sensory array located on a front side at a center of the cylindrical housing; and
a plurality of attachment arms that mount to a plurality of wheel nuts about a center of a vehicle wheel and that position the cylindrical housing parallel to a center of the vehicle wheel, wherein each attachment arm of the plurality of attachment arms comprises:
a rigid body that extends lengthwise to a particular distance;
a first magnet at a proximal end of the rigid body that connects to the cylindrical housing via a magnetic force; and
a second magnet at a distal end of the rigid body that connects to a wheel nut of the vehicle wheel via a magnetic force.
